(19) United States
(12) Patent Application Publication
(10) Pub. No.: US 2015/0309548 A1
(43) Pub. Date: Oct. 29, 2015

(54) REMOTE POWER MANAGEMENT OF AN ADAPTER

(71) Applicant: Vivint, Inc., Provo, UT (US)

(72) Inventor: Jeffrey G. Thomas, Draper, UT (US)

(73) Assignee: Vivint, Inc., Provo, UT (US)

(21) Appl. No.: 14/262,533

(22) Filed: Apr. 25, 2014

(51) Int. Cl. G06F 1/26

(52) U.S. Cl. CPC G06F 1/266

(57) ABSTRACT

Methods and systems are described for controlling a power management of a remote adapter. According to at least one embodiment, an adapter assembly for controlling a power supply includes an electrical interface arranged to receive power from a power source, a first circuit arranged to supply power to a light emitting device from the electrical interface, a second circuit arranged to supply power to a security device from the electrical interface, and a controller in communication with a wired or wireless receiver where the controller is configured to independently control a level of power of the first circuit.

### BACKGROUND

Security systems often include security cameras that are positioned to view areas of interest. These cameras are equipped to take footage of activity that occurs within their field of view. Such footage may be stored locally in a format that allows personnel to view the footage at a later time. In other examples, such security cameras are connected to a cloud based storage system where the video footage is stored. Such security cameras may be located in indoor and outdoor environments.

Often, the security camera includes a power cable that is configured to direct power from a nearby electrical socket to the camera. Other types of security cameras include batteries that have sufficient power to operate the cameras for a desired amount of time. However, such removable power sources have a limited amount of power, which imposes a risk that the camera will run out of power if the removable power source is not replaced within an appropriate time frame.

### SUMMARY

Methods and systems are described for remote power management of an adapter. According to at least one embodiment, an adapter assembly includes an electrical interface arranged to receive power from a power source, a first circuit arranged to supply power to a light emitting device from the electrical interface, a second circuit arranged to supply power to a security device from the electrical interface, and a controller in communication with a wireless receiver where the controller is configured to independently control a level of power of the first circuit.

In some examples, the first electrical circuit is, in part, incorporated into a threaded socket. Further, the second electrical circuit is, in part, incorporated into a plug. The security device may be a security camera, a motion detector, another type of security device, or combinations thereof.

The adapter assembly may include a processor and memory in electronic communication with the processor. Instructions may be stored in the memory and are executable by the processor to adjust the level of power to the first circuit in response to receiving a wireless signal. In some cases, the instructions are executable by the processor to cut off power to the light emitting device by breaking the first electrical circuit or to dim the light emitting device. In some instances, adjusting the first power level includes turning off power to the first electrical terminal.

The adapter assembly may include a mount that is configured to attach to a light socket. Such a light socket may be a standard socket often installed in homes and other types of building for providing light to the areas around and in the building. When attached to the light socket, the adapter can draw from the same power source that a light bulb would have otherwise drawn from if the light bulb were attached to the light socket. Thus, in situations where the light bulb would have drawn from the building's power source, the adapter is electrically connected to the building's power source and can provide power therefrom to the loads electrically connected to the first circuit and the second circuit. In other examples, the adapter assembly receives its power from a wireless power source.

In another aspect of the principles described herein, a method for remotely controlling a power supply includes providing, with an adapter assembly, a first power level to a light emitting device and a second power level to a security device, receiving a wireless signal with the adapter assembly, and adjusting the first power level to the light emitting device while maintaining the second power level to the security camera. In some situations, adjusting the first power level to the light emitting device includes diminishing the first power level such that the light emitting device dims.

In yet another aspect of the principles described herein, an automation system and/or security system includes an adapter assembly arranged to connect with a power supply, a first circuit arranged to supply power to a security device, a second circuit arranged to supply power to different device, and a controller in communication with a wireless receiver where the controller is configured to independently control a level of power to the first circuit and the second circuit.

In some instances, the different device is a light emitting device. Further, the automation system and/or security system may include a control unit configured to control the automation and/or security system. Such a control unit may include a wireless transceiver that is in communication with the wireless receiver. Also, the automation system and/or security system may include a remote switch that includes a wireless transceiver that is in communication with the wireless receiver of the adapter assembly.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example of an environment in which the present systems and methods may be implemented;

FIG. 2 is a block diagram of an example of an adapter assembly of the environment shown in FIG. 1;

FIG. 3 is a front view of an example of an adapter assembly of the environment of FIG. 1;

FIG. 4 is a front view of an example of an adapter assembly of the environment of FIG. 1;

FIG. 5 is a block diagram of an example of a remote switch of the environment of FIG. 1;

FIG. 6 is a block diagram of an example of a mobile device of the environment of FIG. 1;

FIG. 7 is a block diagram of an example of a control unit of the environment of FIG. 1;

FIG. 8 is a flow diagram illustrating an example of a method for remote power management of an adapter assembly;

FIG. 9 is a flow diagram illustrating an example of a method for remote power management of an adapter assembly; and

FIG. 10 is a block diagram of a computer system suitable for implementing the present systems and methods of FIG. 1.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to home automation and home security, and related security systems and automation for use in commercial and business settings. More specifically, the systems and methods described herein relate to an adapter assembly that allows one circuit to have a diminished amount of power while the power level of another circuit is maintained.

Often, a home owner desires to mount a security camera or another type of security device in an area on the outside of the home where there is no power outlet within a sufficient reach to supply power to the camera or other security device. As a result, the owner has to use an extension cord or has to mount the camera in an area that is less desirable, but is within reach of the power outlet.

The principles described herein allow the security device to be installed at the light socket that already exists on the outside of the building or home. The power from the light socket powers the devices connected to or incorporated into the adapter assembly. The adapter assembly may be equipped with a first circuit that is at least partially incorporated into a light socket built into the adapter. Thus, the adapter assembly can be secured to the existing light socket and a light emitting device (i.e. a light bulb, light emitting diode, etc.) can be secured to and receive power from the adapter assembly. Additionally, the adapter assembly can also include a power cord that can extend to a security device (i.e. camera, motion detector, etc.). Thus, the security device can be mounted to an area nearby the adapter assembly. In some instances, a security device can be incorporated into the adapter assembly. Regardless of whether the security device is incorporated into the adapter assembly or the security device is electrically connected to the adapter assembly, the security device receives power from the same source as the light emitting device.

As a result of the security device and the light emitting device receiving power from the same source, when a portion of the circuit carrying power to the adapter assembly is broken, power to both the security device and the light emitting device is broken. Frequently, a home owner desires to turn off the lighting around his or her home. Consequently, the home owner will generally flip a switch that turns off power to a light socket in which the adapter assembly is secured. As a result, power to both the security device and the light emitting device is lost. Unfortunately, the home owner may desire to have power supplied continuously to the security device, even when the home owner desires to have the lights turned off.

The principles described herein include a controller within the adapter that controls the amount of power that flows to the light emitting device. The controller may be in communication with any appropriate mechanism that can reduce, increase, cut off, or otherwise adjust the power to the light emitting device while maintaining power to the security device. In some examples, this is accomplished by providing independent circuits to the light emitting device and to the security device. At least the circuit supplying power to the light emitting device can be independently altered with a dimming circuit, a circuit breaker, another type of mechanism, or combinations thereof without significantly affecting the power to the other circuit. For example, the power to the light emitting device can be cut off without affecting the operation or the quality of operation of the security device. Thus, the principles described herein provide an adapter that allows a user to place security devices in different on the outside of a building by using the light sockets without having the drawback of losing power to the security device when the lights are turned out.

As used herein, the term “module” includes a combination of hardware and programmed instructions that are necessary for performing the designated function of the module. Components of the modules may be located on the same physical device or some of the components may be located at remote locations that are in communication with the other components of the module.

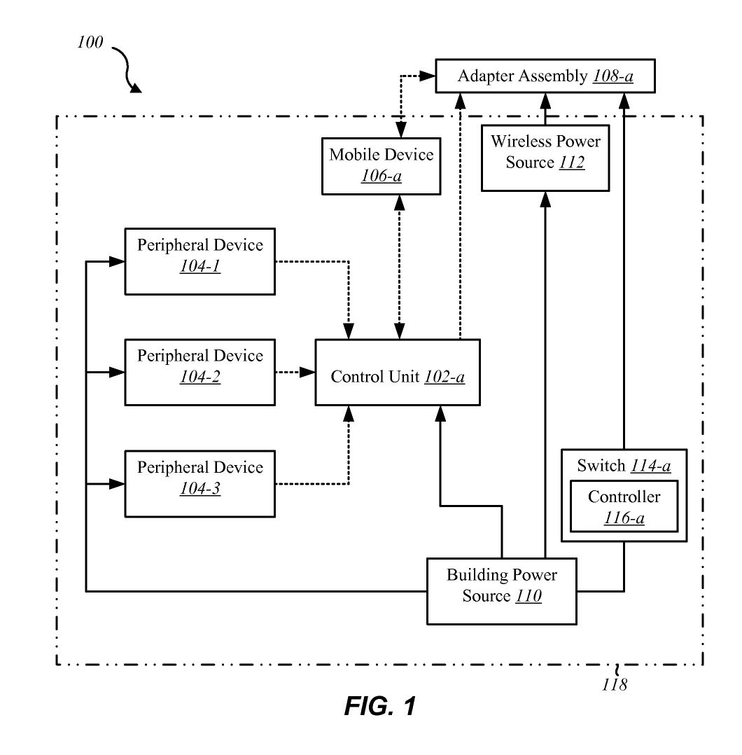

FIG. 1 is a block diagram depicting one embodiment of an environment 100 in which the present systems and methods may be implemented. In this example, the environment includes a control unit 102-a that is in communication with multiple peripheral devices 104-1, 104-2, 104-3. The control unit 102-a is also in communication with a mobile device 106-a. The control unit 102-a may be in direct communication with the mobile device 106-a or in communication with the mobile device 106-a through an intermediate device, such as a cloud based device.

The control unit 102-a may control at least a part of the security system and/or automation system. For example, each of the peripheral devices 104-1, 104-2, 104-3 may send information to the control unit 102-a where the signals are processed. The peripheral devices 104-1, 104-2, 104-3 may include, for example, a camera sensor, audio sensor, forced entry sensor, shock sensor, proximity sensor, boundary sensor, appliance sensor, light fixture sensor, temperature sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, heartbeat sensor, breathing sensor, oxygen sensor, carbon dioxide sensor, brain wave sensor, movement sensor, voice sensor, other types of sensors, actuators, or combinations thereof.

These peripheral devices 104-1, 104-2, 104-3 may send raw information to the control unit 102-a where no processing has occurred prior to sending the information to the control unit 102-a. In other examples, at least a portion of the information is processed prior to sending the information to the control unit 102-a. In some cases, at least most of the processing occurs at the control unit 102-a.

The control unit 102-a may make decisions based on these communications from the peripheral devices 104-1, 104-2, 104-3. For example, based on the information sent from the peripheral devices 104-1, 104-2, 104-3 to the control unit 102-a, the control unit 102-a may make a decision to activate an alarm, adjust a climate control setting, open or close a window, lock or unlock a door, control a security parameter, manage energy consumption, check the status of a door, locate a person or item, control lighting, control cameras, receive notifications regarding a current status or anomaly associated with a building, perform another task, or combinations thereof.

In some examples, the control unit 102-a includes a user interface where the user can interact with the control unit 102-a. For example, the user can manually give instructions to the control unit 102-a to adjust a network setting, actuate a peripheral device 104, perform another system task, or combinations thereof.

The mobile device 106-a may be in communication with the control unit 102-a. For example, the mobile device 106-a may be used by a home owner to instruct the control unit 102-a to cause a peripheral device 104 to perform an action, such as lock a door, open a window, turn on a video camera, turn down a volume of a speaker, another action, or combinations thereof. Further, the control unit 102-a may send information to the mobile device 106-a to present to the home owner. For example, the control unit 102-a may send instructions to the mobile device 106-a to display a current temperature in the home, to indicate that an instructed task has been completed, or request instructions from the home owner.

Any appropriate mechanism for communicating between the control unit 102-a and the mobile device 106-a may be used. In some examples, a wireless network is utilized to communicate between the control unit 102-a and the mobile device 106-a. Examples of networks that may be used may include, but are not limited to, local area networks (LAN), wide area networks (WAN), virtual private networks (VPN), wireless networks (using 802.11, for example), and/or cellular networks (using 3G and/or LTE, for example), Bluetooth networks, z-wave networks, other types of networks, or combinations thereof.

Any appropriate type of mobile device may be used to communicate with the control unit 102-a. For example, an application may be downloaded to a smart phone, electronic tablet, a laptop, another type of mobile device, or combinations thereof. In some embodiments, the mobile device 106-a is a portable electronic device with a touch screen display.

The control unit 102-a may be powered from a building power source 110 or another type of power source that supplies power to other devices in the home or building. For example, the building power source 110 may be connected to the power grid that supplies power to the building from a remote electricity generating station. In other examples, the building power source 110 may be a generator, at least one solar panel, at least one wind turbine, an alternating current source, a biofuel source, a nuclear source, another type of power source, or combinations thereof.

The building power source 110 may also supply power to an adapter assembly 108-a that may be mounted to the outside of a wall 118 of the building. In other examples, the adapter assembly 108-a is at a location within the building. The adapter assembly 108-a may include an electrical interface that is configured to receive power from the building power source 110. The electrical interface may include at least two circuits that are arranged to supply power to independent devices. The independent devices may be incorporated into the adapter assembly, be external to the adapter assembly, or combinations thereof.

For example, at least one of the circuits may be arranged to supply power to a socket incorporated into the adapter assembly. Such a socket may be a light socket, an incandescent light bulb socket, a light emitting diode socket, a fluorescent light bulb socket, a halogen light socket, a neon light socket, an electrical outlet, another type of power socket, or combinations thereof. Further, at least one of the circuits may provide power to a power cord with an electrical plug. In such examples, the user can select from multiple types of devices that can connect to a power cord. For example, the user may install a security camera, a motion detector, another type of security device, a speaker, a lighting device, another type of device, or combinations thereof to the power cord. Additional, at least one of the circuits may be arranged to provide power to a device incorporated into the adapter assembly 108-a. A non-exhaustive list of devices that may be arranged to receive power through at least one of the circuits includes a security camera, a motion detector, another type of security device, a speaker, a lighting device, another type of device, or combinations thereof.

The adapter assembly 108-a may include a controller that can independently control the amount of power that is available to each circuit. For example, the controller may be in communication with a circuit breaker or a dimming circuit that can adjust the amount of power available on one of the multiple circuits. Such power adjustment mechanisms may be dedicated to a single circuit or a subset of the circuits within the adapter assembly 108-a. By independently actuating such a power adjustment mechanism, at least one of the circuits will experience a power level adjustment while at least one other circuit will substantially maintain its power level. For purposes of this disclosure, the phrases associated with maintaining a power level of a circuit refer to the circuit's ability to continue to operate a device to which it is connected at substantially the same performance. For example, if a first circuit supplies power to a light emitting device and a second circuit provides power to a security camera, and the second circuit experiences a voltage change that minimally impacts the performance of the security camera as a result of the controller cutting off power to the light emitting device, then the second circuit has maintained its power level.

The adapter assembly 108-a may provide the home owner the ability to switch off one of the devices receiving power through the adapter assembly 108-a without affecting the power level of the other devices receiving power through the adapter assembly 108-a. For example, the adapter assembly 108-a may continuously supply power to certain kinds of devices while having the ability to turn other types of devices on and off. The use of a security camera and a light emitting device may be well suited for such an adapter assembly because a security camera is a type of device where it is desirable to provide constant power while the light emitting device is just desirable in certain types of conditions, such as when it is dark outside.

The controller of the adapter assembly 108-a may be controlled wirelessly with any appropriate device. A non-exhaustive list of devices that may be used to communicate with the adapter's controller include, but are not limited to, the mobile device 106-a, the control unit 102-a, another control device of the automation system and/or security system, a switch 114-a, another type of device, or combinations thereof.

The mobile device 106-a may include an application specific program that allows the mobile device 106-a to communicate with the controller of the adapter assembly 108-a. Such an application may allow the user to turn off an outside light while continuing to supply power to the security device where both the outside light and the security device receive power through the adapter assembly 108-a.

Likewise, the control unit 102-a may allow the user to remotely control the power levels to the devices receiving power through the adapter assembly 108-a. In such an example, the control unit 102-a may include a user interface that allows the user to give instructions to the controller of the adapter assembly 108-a. Any appropriate type of user interface may be used in accordance with the principles described herein. For example, such a user interface may include a touch screen, a button, a level, a dial, a key board, another type of user interface, or combinations thereof.

The switch 114-a may be located at any appropriate location of the home or other type of building. For example, the switch may be located indoors or outdoors. The switch 114-a may have been originally wired to turn on or off power to the light socket to which the adapter assembly is secured. Such a switch 114-a may be retrofitted to include a controller 116-a that communicates wirelessly with the controller of the adapter assembly 108-a. In other examples, the controller 116-a utilizes the power line to send instructions to the adapter assembly 108-a. The retrofitting of the switch 114-a may have the effect of breaking the circuit in the adapter assembly 108-a that provides power to the light emitting device instead of breaking the circuit locally at the switch 114-a. In this manner, power can still be received at the adapter assembly 108-a even though the light is switched off. In some examples, the switch 114-a communicates with a dimming circuit of the adapter assembly 108-a. Thus, the amount of light can be increased or decreased remotely through the switch 114-a.

In another example, the adapter assembly may receive power through a wireless power source 112. In such an example, the wireless power source may receive its power from the building power source (i.e. plugged into a wall mounted electrical outlet). The wireless power source 112 may be positioned nearby the adapter assembly 108-a to provide the power. In some instances, the wireless power source 112 is configured to power the adapter assembly 108-a through a window, a wall, another object, or combinations thereof. One arrangement may include positioning the adapter assembly 108-a on an outside of the building near a window and placing the wireless power source 112 on the other side of the window such that the adapter assembly 108-a can receive power from the wireless power source 112.

Any appropriate mechanism for wireless power transmission may be used in accordance with the principles described herein. For example, wireless charging may be accomplished with direct induction, resonant magnetic induction, electromagnetic radiation in the form of microwaves or lasers, other wireless charging mechanisms, or combinations thereof.

Inductive charging can use an electromagnetic field to transfer energy between the wireless power source 112 and the adapter assembly 108-a. Both the wireless power source 112 and the adapter assembly 108-a may include an inductive coupling. With such an arrangement, power from the wireless power source 112 can direct power to the adapter assembly 108-a and charge batteries located therein and/or run the device. An inductive coupling in the wireless power source 112 may include an induction coil that focuses an alternating electromagnetic field towards the adapter assembly by shielding the coil to prevent energy from radiating in directions away from the adapter assembly. The adapter assembly may include a second induction coil that takes power from the electromagnetic field and converts it back into electrical current to charge its battery. Generally, resonant inductive couplings can be used when the distances between inductive coils are farther apart.

The inductive coils may incorporate any appropriate type of characteristic that can control excess heat, interference, cross talk, power transfer efficiency, or other types of conditions. For example, the coils may have ultra-thin cross sections, operate at high frequencies, use optimized drivers, and so forth.

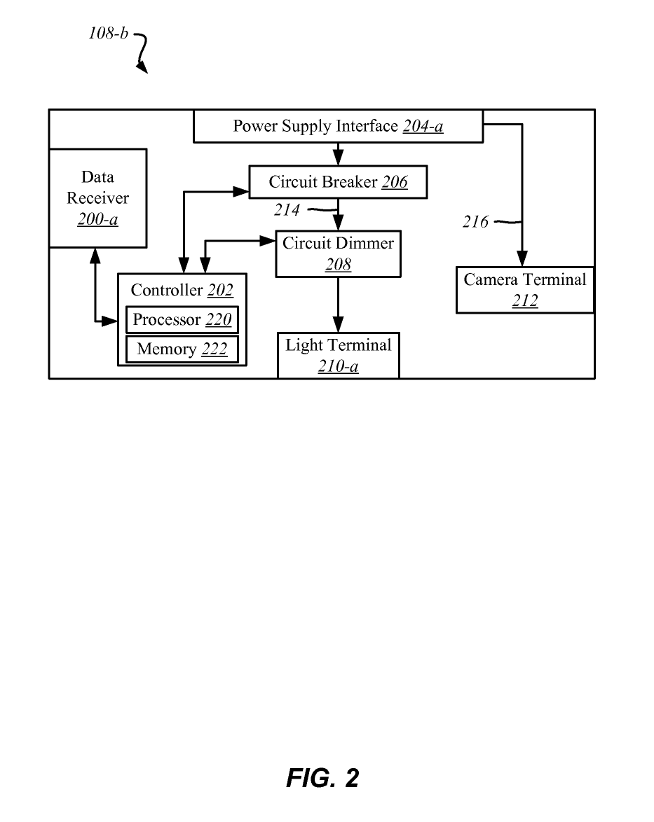

FIG. 2 is a block diagram illustrating one example of an adapter assembly 108-b. In this example, the adapter assembly 108-b includes a wireless data receiver 200 that is in communication with a controller 202. Further, the adapter assembly 108-b also has a power supply interface 204-a where the adapter assembly 108-b receives its power. A first circuit 214 directs power from the power supply interface 204-a to a light terminal 210-a that is configured to receive a light emitting device. In some example, the light terminal 210-a is a threaded socket. The first circuit 214 is in communication with a circuit breaker 206 and a circuit dimmer 208 that are both in communication with the controller 202. Additionally, a second circuit 216 directs power from the power supply interface 204-a to a camera terminal 212.

In the example of FIG. 2, the wireless data receiver 200 receives the data at the adapter assembly 108-b while the power supply interface 204-a receives the power. In other examples, adapter assembly 108-b receives data over the power line or over another type of electrically conductive medium independent of the power line. Any appropriate type of power supply interface may also be used in accordance with the principles described herein. For example, the power supply interface 204-a may include electrical contacts, an inductive coil, a capacitive interface, another type of interface, or combinations thereof.

Further, any appropriate type of wireless data receiver may be used in accordance with the principles described herein. For example, the wireless data receiver 200 may be capable of communicating using the ZigBee protocol, Z-Wave protocol, BlueTooth protocol, Wi-Fi protocol, Global System for Mobile Communications (GSM) standard, another standard, or combinations thereof.

The data received at the wireless data receiver 200 may include instructions for adjusting the power level of the first circuit 214. This information may be processed at the controller, where the controller 202 includes a processor 220 and memory 222 that causes the instructions to be executed. The controller 202 may cause the circuit breaker 206 to break the first circuit 214 to stop electricity from flowing. Such a break in the first circuit 214 will stop the power from flowing to the light terminal 210-a to stop and thereby turn off any light emitting device in electrical communication with the light terminal 210-a. Likewise, if the instructions from the wireless data receiver 200 are to turn the light on, the controller 202 can cause the circuit breaker 206 to restore the first circuit 214, thereby causing power to resume flowing to the light terminal 210-a.

The controller can also follow instructions from the wireless data receiver 200 by using the circuit dimmer 208. Any appropriate type of circuit dimmer may be used in accordance with the principles described herein. The circuit dimmer 208 can be used to vary the power level by decreasing or increasing the root mean square voltage and, hence, the mean power to the light terminal 210-a. As a result, the intensity of the light output can be varied.

In some examples, the circuit dimmer 208 is built from silicon-controlled rectifiers which switches between a low resistance “on” state and a high resistance “off” state. In another example, the circuit dimmer 208 is a variable resistor, which can dissipate power as heat by functioning as a voltage divider. In yet another example, an analog dimmer is used. Analog dimmers may use a separate wire attached to the circuit that carries a voltage between zero and ten volts. Additionally, a digital dimmer may be used. Such dimmer may use a demultiplexer which selects the circuit to dim. In yet other examples, the circuit dimmer 208 may be a coil-rotation transformer, an autotransformer dimmer, a thyristor dimmer, another type of dimmer, or combinations thereof.

The circuit dimmer 208 may be used to completely turn off a light emitting device connected to the light terminal 210-a. For example, the circuit dimmer 208 may reduce the voltage in the first circuit 214 to zero volts and thereby prevent power from reaching the light terminal 210-a.

While this example has been described with both a circuit breaker 206 and a circuit dimmer 208, the adapter assembly 108-b may incorporate just one of these power adjusting mechanisms, a different type of power adjusting mechanism, or combinations thereof. For example, the circuit dimmer 208 may be used to both dim and break the circuit. In situations where an existing light switch 114 is retrofitted to communicate with a switch controller 116 and just has a mechanism to indicate whether the light should be on or off, the switch controller 116 can send a message to the wireless data receiver 200 with on and off commands. The controller can instruct the dimmer to reduce the voltage to zero when an “off” command is received, and to increase the voltage to a maximum when an “on” command is received.

As the controller 202 causes the power level of the first circuit 214 to change, the power level to the second circuit 216 remains the same. Thus, as the power level to the light terminal changes, the power to the camera terminal will remain substantially the same.

While this example has been described with reference to a light terminal 210-a and a camera terminal 212, the terminals may be configured to provide power to any number of devices. In some examples, at least one of the terminals is constructed to support a specific device. Likewise, at least one of the terminals may be constructed with a terminal interface that conforms to a standard type of terminal so that the terminal can support a wider number of device types.

Also, while this example has been described with two circuits providing power to two different terminals 210-a, 212, the adapter assembly may include any number of circuits with an appropriate number of terminals. For example, three or more terminals with one-to-one ratios between the circuits to terminals may be incorporated into an adapter assembly. In another example, one circuit may be dedicated to multiple terminals. As a result, as the power level to that circuit is adjusted, the power level for each of the downstream terminals is also affected.

Further, while this example has been shown with the controller 202 having just the ability to adjust the power level of the first circuit 214, in other examples, the controller has the ability to control the power level of the second circuit 216. For example, the second circuit 216 may incorporate a power cord and plug that are capable of connecting to a wide variety of devices. In such an example, the user may desire to selectively turn off a device connected to the power cord while maintaining the current power level of the first circuit.

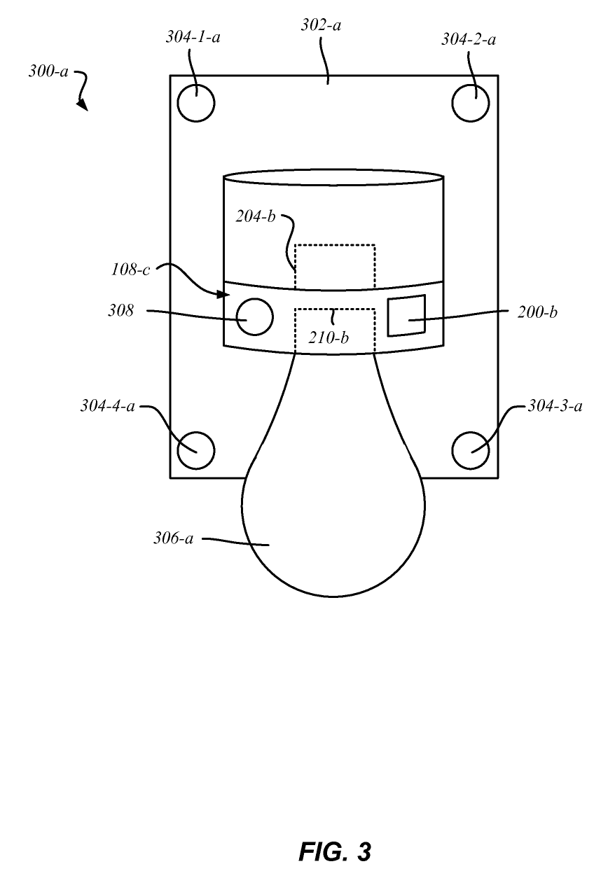

FIG. 3 is a block diagram illustrating one example of an adapter assembly 108-c. In this example, the adapter assembly 108-c is attached to a lighting fixture 300-a with a mount 302-a having multiple openings 304-1-a, 304-2-a, 304-3-a, 304-4-a for receiving a fastener to attach the mount 302 to the outside of a building. The adapter assembly 108-c is secured to the lighting fixture 300-a at the power supply interface 204-b. A light bulb 306-a is secured with the light terminal 210-b of the adapter assembly 108-c.

The power supply interface 204-b may be shaped and made of an appropriate material to make an electrical connection with the light receiver as it is secured to the lighting fixture. In some examples, the power supply interface 204-b is shaped and made of the same material as an end of a light bulb 306-a and the adapter assembly 108-c is connected to the lighting fixture 300-a in a similar manner as a light bulb would be attached to the lighting fixture 300-a.

In this example, a camera 308 is incorporated into the adapter assembly 108-c. The camera 308 may be attached to a second terminal of a second circuit within the adapter assembly 108-c. Further, a wireless receiver 200-b is also incorporated into the adapter assembly 108-c. The instructions received with the wireless receiver 200-b can be processed by the controller 202 to adjust the power level to the light bulb 306-a without affecting the power level to the camera 308. As a result, the camera 308 can have adequate power to operate while the light bulb 306-a is turned off.

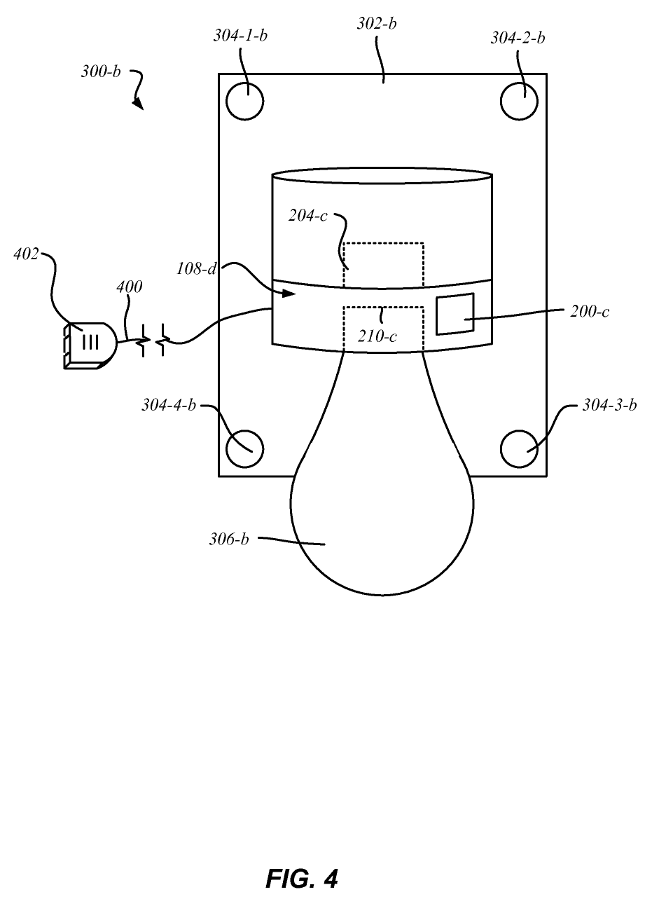

FIG. 4 is a block diagram illustrating one example of an adapter assembly 108-d. In this example, the adapter assembly 108-d is attached to a lighting fixture 300-b with a mount 302-b having multiple openings 304-1-b, 304-2-b, 304-3-b, 304-4-b for receiving a fastener to attach the mount 302-b to the outside of a building. The adapter assembly 108-d is secured to the lighting fixture 300-b at the power supply interface 204-c. A light bulb 306-b is secured to the adapter assembly 108-d at the light terminal 210-c.

In this example, a cord 400 with a plug 402 is incorporated into the adapter assembly 108-d. The plug 402 may be the second terminal of a second circuit within the adapter assembly 108-d. Further, a wireless receiver 200-c is also incorporated into the adapter assembly 108-d. The instructions received with the wireless receiver 200-c can be processed by the controller 202 to adjust the power level to the light bulb 306-b without affecting the power level to the plug 402. As a result, the plug 402 can have adequate power to operate while the light bulb 306-b is turned off. Any appropriate device may be attached to the plug 402, such as a security camera, a motion detector, another type of security device, a speaker, another type of device, or combinations thereof.

In some examples, the plug 402 is a generic plug that follows industry standards that allow the plug 402 to be compatible with a wide variety of commercial products. The plug 402 may be a female portion of a plug or a male portion of plug. In some examples, the plug 402 is a customize type of male AC adapter connector that can connect directly to the security device. Such a connector may incorporate an AC to DC converter or other features to enable the operation of the security device. While the examples above have been described with reference to specific characteristics of a plug, any appropriate type of plug may be used in accordance with the principles described herein.

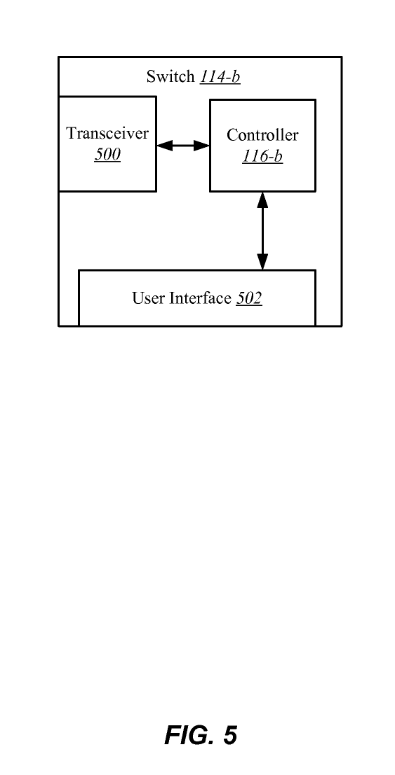

FIG. 5 is a block diagram illustrating one example of a switch 114-b. In this example, the switch 114-b has a wireless transceiver 500, a controller 116-b, and a user interface 502. In other examples, the switch 114-b includes a transceiver constructed to receive data over the power line or an independent data line.

Any appropriate type of user interface 502 may be used in accordance with the principles described herein. For example, the switch 114-b may be a retrofitted light switch that previously existed in a home or building. Such a switch may have a traditional looking user interface, such as a toggle switch where a first vertical orientation of the toggle switch represents that the light is on while a second vertical orientation of the toggle switch represents that the light is off. In other examples, the user interface 502 may include a push button, a rocker, a pull chain, pull cord, a touch sensitive interface, another type of interface, or combinations thereof. In some examples, the switch 114-b is a dimmer switch that allows the user to vary the intensity of light such as with a slider, dial, buttons, or another type of switch that allows the user to make adjustments. In other examples, the transceiver 500 and the controller are separate devices that are in communication with the switch 114-b.

In some examples, a retrofitted switch 114-b causes the electrical pathway between the building power source 110 and the adapter assembly 108 to be permanently joined so that there is no user option for disconnecting power to the adapter assembly 108 at the switch 114-b. In such a situation, the breaker box which provides circuit breakers to multiple electrical circuits in the home or building can still be used if it is desirable to stop power to the adapter assembly. In other examples, the switch 114-b may still provide an option for cutting power to the adapter assembly 108 at the switch 114-b while also providing the ability to remotely control the power circuits in the adapter assembly 108. In such an example, the switch 114-b may include one mechanism for controlling the amount of power to the adapter assembly 108 and another mechanism for controlling the amount of power to the light terminal 210 of the of the adapter assembly. In some instances, the switch 114-b may include an independent control mechanism for each of the power circuits within the adapter assembly 108.

The controller 116-b is in communication with the user interface 502. Based on input from the user interface 502, the controller 116-b sends instructions to the wireless transceiver 500 to forward to the adapter assembly 108. Any appropriate type of wireless data receiver may be used in accordance with the principles described herein. For example, the wireless data receiver 200 may be capable of communicating using the ZigBee protocol, Z-Wave protocol, BlueTooth protocol, Wi-Fi protocol, Global System for Mobile Communications (GSM) standard, another standard, or combinations thereof.

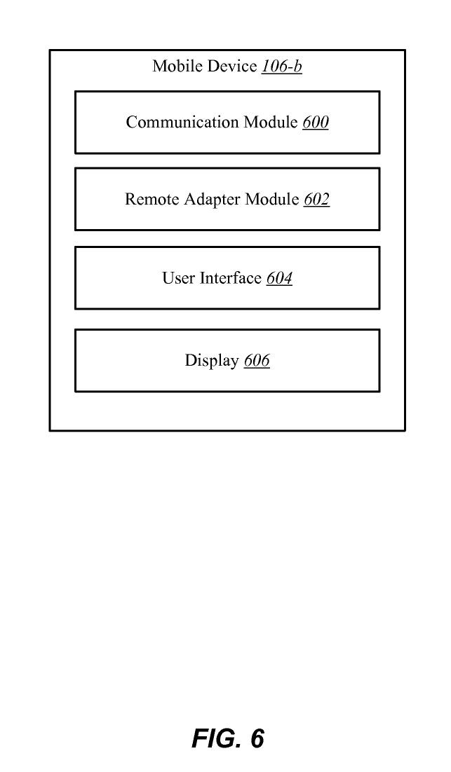

FIG. 6 is a block diagram illustrating one example of a mobile device 106-b. In this example, the mobile device 106-b includes a communication module 600, a remote adapter module 602, a user interface 604, and a display 606.

The communication module 600 can be configured to communicate directly with the adapter assembly 108 or indirectly with the adapter assembly 108 by communicating through the control unit 102, a cloud based device, another type of device, or combinations thereof. Based on input from the user interface 604, the communication module 600 sends instructions to the adapter assembly 108. Any appropriate type of wireless transceiver may be used in accordance with the principles described herein. For example, the communication module 600 may be capable of communicating using the ZigBee protocol, Z-Wave protocol, BlueTooth protocol, Wi-Fi protocol, Global System for Mobile Communications (GSM) standard, another standard, or combinations thereof.

The remote adapter module 602 can take input from the user interface 604 and determine the appropriate power level for the appropriate circuit in the adapter assembly 108. In response to determining that a change to a power level is to be made to one of the circuits, the remote adapter module 602 generates instructions, which are sent to the communication module 600 to send to the adapter assembly 108.

In some instances, the display 606 of the mobile device 106-b may include a power level status of each of the circuits and/or their associated devices. For example, an indicator associated with each of the devices powered by the adapter assembly 108 may indicate whether the device is powered on, powered off, and/or the power level in the form of a percentage, or another type of measurement. In such an example, the user can confirm whether the devices are receiving the desired levels through the mobile device 106-b.

Any appropriate type of user interface 604 may be incorporated into the mobile device 106-b to operate the application that controls the power management of the adapter assembly 108. Such user interfaces may include a touch screen, a microphone, a key pad, a scroll button, or another type of user interface, or combinations thereof.

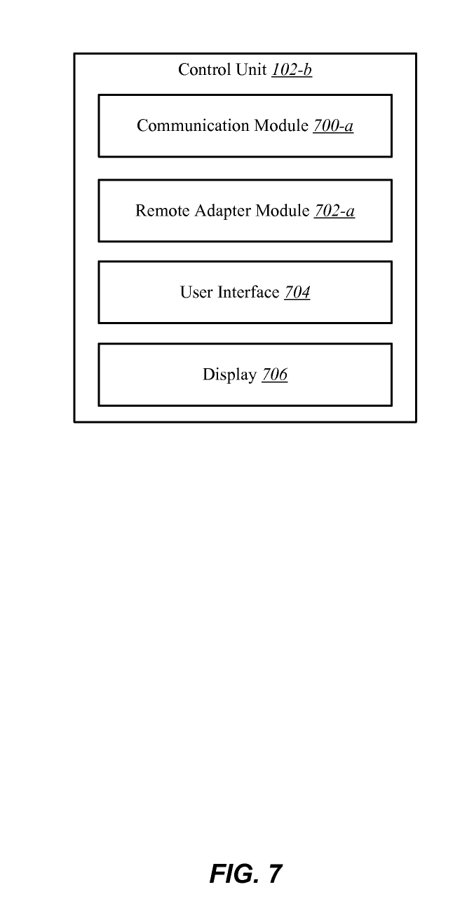

FIG. 7 is a block diagram illustrating one example of a control unit 102-b. In this example, the control unit 102-b has a communication module 700-a, a remote adapter module 702-a, a user interface 704, and a display 706.

The communication module 700-a can be configured to communicate directly with the adapter assembly 108 or indirectly with the adapter assembly 108 by communicating through a cloud based device, another type of device, or combinations thereof. Based on input from the user interface 704, the communication module 700-a sends instructions to the adapter assembly 108. The communication module 700-a may use any appropriate type of wireless receiver in accordance with the principles described herein. For example, the communication module 700-a may be capable of communicating using the ZigBee protocol, Z-Wave protocol, BlueTooth protocol, Wi-Fi protocol, Global System for Mobile Communications (GSM) standard, another standard, or combinations thereof.

The remote adapter module 702-a can take input from the user interface 704 and determine the appropriate power level for the appropriate circuit in the adapter assembly 108. In response to determining that a change to a power level is to be made to one of the circuits, the remote adapter module 702-a generates instructions, which are sent to the communication module 700-a to forward to the adapter assembly 108.

In some instances, the display 706 of the control unit 102-b may include a power level status of each of the circuits and/or their associated devices. For example, an indicator associated with each of the devices powered by the adapter assembly 108 may indicate whether the device is powered on, powered off, and/or the power level in the form of a percentage, or another type of measurement. In such an example, the user can confirm whether the devices are receiving the desired levels through the control unit 102-b.

Any appropriate type of user interface 704 may be incorporated into the control unit 102-b to operate the application that controls the adapter assembly 108. Such user interfaces may include a touch screen, a microphone, a key pad, a scroll button, or another type of user interface, or combinations thereof.

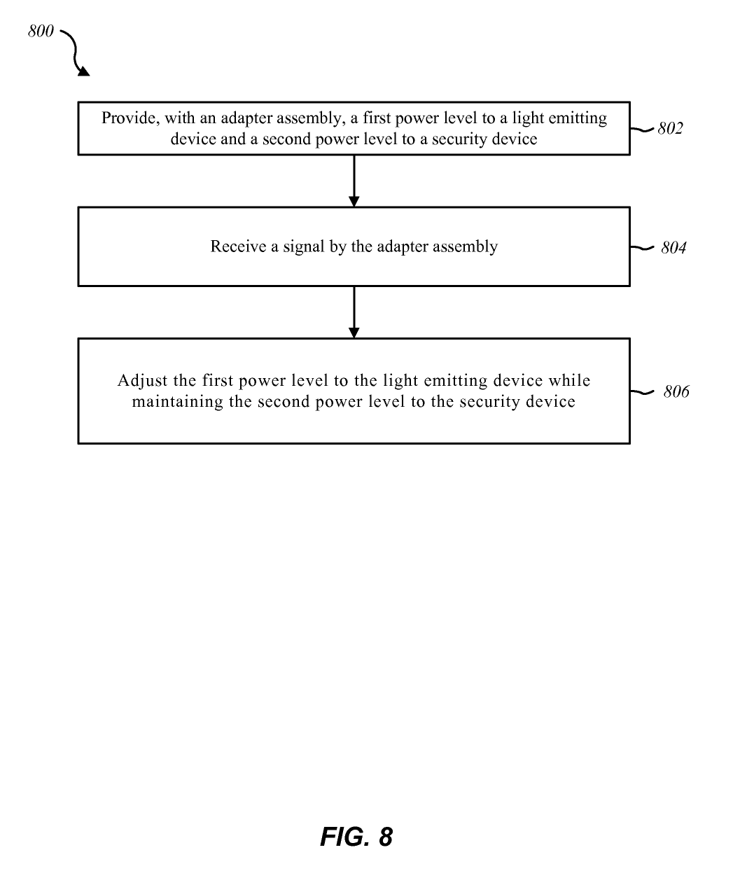

FIG. 8 is a flow diagram illustrating an example of a method 800 for remote power management of an adapter assembly. In this example, the method 800 includes providing 802, with an adapter assembly, a first power level to a light emitting device and a second power level to a security device, receiving 804 a signal by the adapter assembly, and adjusting 806 the first power level to the light emitting device while maintaining the second power level to the security device. Such a method 800 may be implemented with an adapter assembly 108 shown in FIGS. 1-4. In other examples, method 800 may be performed generally by the environment 100 shown in FIG. 1.

At block 802, the adapter assembly 108 provides power to each of the circuits incorporated therein at appropriate levels based on instructions previously received to both a light emitting device and a security device. The light emitting device has its own dedicated power circuit, and the security device has its own dedicated power circuit. The security device may be a security camera, a motion detector, another type of security device, or combinations thereof.

At block 804, the adapter assembly 108 receives a signal. Such a signal may include instructions for changing a power level of at least one of the circuits. Any appropriate type of data may be included in the signal, and such information may be formatted in any appropriate order. As an example, the signal may include a packet that includes an identification of the adapter assembly 108, an identification of the power circuit within the adapter assembly 108, and a desired power level.

At block 806, the adapter assembly 108 adjusts the power level to the light emitting device while maintaining the power level to the security device. In some examples, this includes increasing the amount of power to the light emitting device. In other examples, the power level to the light emitting device may be reduced with a dimming circuit or cut off completely with a dimming circuit or a circuit breaker. However, the first power level's adjustment does not substantially affect the second power level.

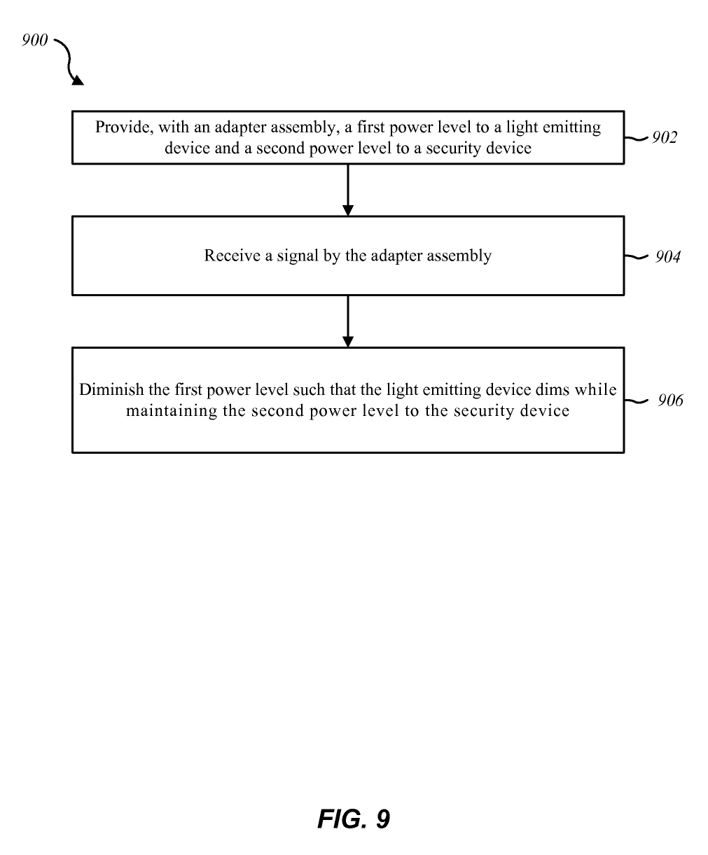

FIG. 9 is a flow diagram illustrating an example of a method 900 for remote power management of an adapter assembly. In this example, the method 900 includes providing 902, with an adapter assembly, a first power level to a light emitting device and a second power level to a security device, receiving 904 a signal by the adapter assembly, and diminishing 906 the first power level such that the light emitting device dims while maintaining the second power level to the security device. Such a method 900 may be implemented with an adapter assembly 108 shown in FIGS. 1-4. In other examples, method 900 may be performed generally by the environment 100 shown in FIG. 1.

In this example, the first circuit may incorporate a dimming circuit that is arranged to reduce the power level of the first circuit without substantially affecting the power level of the second circuit. In some examples, the power level of the first circuit is just partially diminished. In other examples, the dimming circuit diminishes the power level such that the voltage of the first circuit is zero volts. As a result, the first power level is effectively cut off.

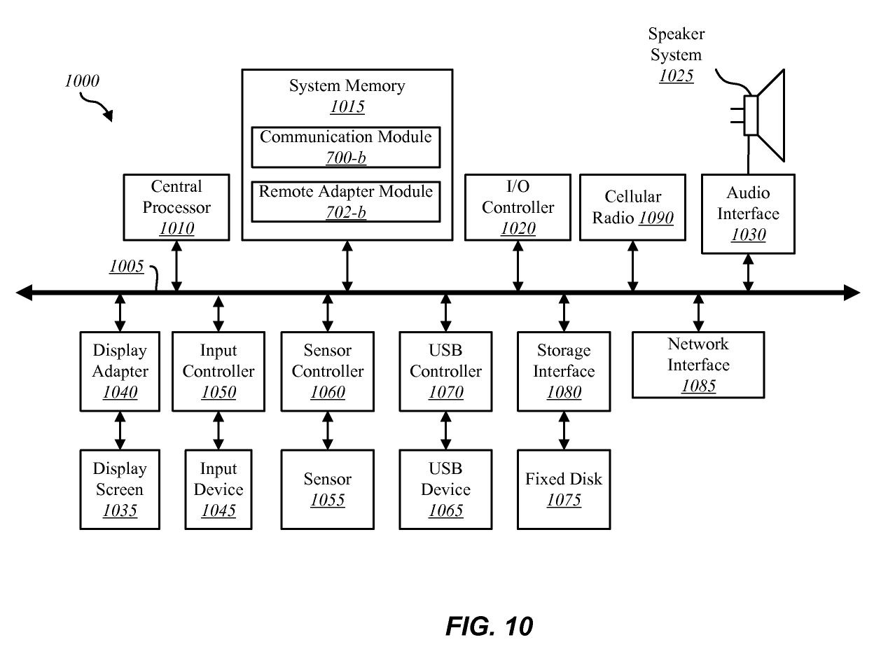

FIG. 10 depicts a block diagram of a controller 1000 suitable for implementing the present systems and methods. The controller 1000 may be an example of the control unit 102 or mobile device 106 in FIG. 1. In one configuration, controller 1000 includes a bus 1005 which interconnects major subsystems of controller 1000, such as a central processor 1010, a system memory 1015 (typically RAM, but which may also include ROM, flash RAM, or the like), an input/output controller 1020, an external audio device, such as a speaker system 1025 via an audio output interface 1030, an external device, such as a display screen 1035 via display adapter 1040, an input device 1045 (e.g., remote control device interfaced with an input controller 1050), multiple USB devices 1065 (interfaced with a USB controller 1070), one or more cellular radios 1090, and a storage interface 1080. Also included are at least one sensor 1055 connected to bus 1005 through a sensor controller 1060 and a network interface 1085 (coupled directly to bus 1005).

Bus 1005 allows data communication between central processor 1010 and system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a communication module 700-b or a remote adapter module 702-b may be used to implement the present systems and methods may be stored within the system memory 1015. These modules may be an example of the modules illustrated in FIG. 7. Applications resident with controller 1000 are generally stored on and accessed via a non-transitory computer readable medium, such as a hard disk drive (e.g., fixed disk 1075) or other storage medium. Additionally, applications can be in the form of electronic signals modulated in accordance with the application and data communication technology when accessed via the network interface 1085.

Storage interface 1080, as with the other storage interfaces of controller 1000, can connect to a standard computer readable medium for storage and/or retrieval of information, such as a fixed disk drive 1075. Fixed disk drive 1075 may be a part of controller 1000 or may be separate and accessed through other interface systems. Network interface 1085 may provide a direct connection to a remote server via a direct network link to the Internet via a POP (point of presence). Network interface 1085 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1000 wirelessly via network interface 1085. In one configuration, the cellular radio 1090 may include a receiver and transmitter to wirelessly receive and transmit communications via, for example, a cellular network.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 10 need not be present to practice the present systems and methods. The devices and subsystems can be interconnected in different ways from that shown in FIG. 10. The aspect of some operations of a system such as that shown in FIG. 10 are readily known in the art and are not discussed in detail in this application. Code to implement the present disclosure can be stored in a non-transitory computer-readable medium such as one or more of system memory 1015 or fixed disk 1075. The operating system provided on controller 1000 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An adapter assembly, comprising:
an electrical interface arranged to receive power from a power source;
a first circuit arranged to supply power to a first device from the electrical interface;
a second circuit arranged to supply power to a second device from the electrical interface, the second device being different from the first device; and
a controller in communication with a wired or wireless receiver, the controller being configured to independently control a level of power of the first circuit.

2. The adapter assembly of claim 1, wherein the first circuit is in part incorporated into a threaded socket.

3. The adapter assembly of claim 1, wherein the second circuit is in part incorporated into a plug.

4. The adapter assembly of claim 1, wherein the second device is a security camera.

5. The adapter assembly of claim 1, wherein the second device is a motion detector.

6. The adapter assembly of claim 1, wherein the controller comprises:
a processor;
memory in electronic communication with the processor; and
instructions stored in the memory, the instructions being executable by the processor to:
adjust the level of the power to the first circuit in response to receiving a signal.

7. The adapter assembly of claim 6, wherein the instructions are further executable by the processor to cut off power to the first device by breaking the first circuit.

8. The adapter assembly of claim 6, wherein the first device is a light emitting device, and the instructions are further executable by the processor to dim the light emitting device.

9. The adapter assembly of claim 6, wherein adjusting the level of the power includes turning off power to an electrical terminal of the first circuit.

10. The adapter assembly of claim 1, further comprising:
a mount that is configured to attach to a light socket.

11. The adapter assembly of claim 1, wherein the power source is a building power source.

12. The adapter assembly of claim 1, wherein the power source is a wireless power source.

13. A method for remotely controlling a power supply, comprising:
providing, with an adapter assembly, a first power level to a light emitting device and a second power level to a security device;
receiving a signal with the adapter assembly; and
adjusting the first power level to the light emitting device while maintaining the second power level to the security device.

14. The method of claim 13, wherein adjusting the first power level to the light emitting device comprises diminishing the first power level such that the light emitting device dims.

15. A system, comprising:
an adapter assembly arranged to connect with a power supply;
a first circuit arranged to direct power to a first device from the power supply;
a second circuit arranged to direct power to a second device from the power supply; and
a controller in communication with a wireless receiver where the controller is configured to independently control a level of power to the first circuit and/or the second circuit.

16. The system of claim 15, further comprising a remote switch comprising a transceiver to communicate with the receiver.

17. The system of claim 15, wherein the first device is a light emitting device.

18. The system of claim 15, further comprising a control unit configured to control a automation system and/or security system, wherein the control unit comprises a transceiver in communication with the receiver.

19. The system of claim 15, wherein the adapter assembly is constructed to be secured to a light socket.

20. The system of claim 15, wherein the second device is a security device.
